(19) United States
(12) Patent Application Publication
(10) Pub. No.: US 2012/0318367 A1
(43) Pub. Date: Dec. 20, 2012

(54) VALVING SYSTEM AND METHOD OF INJECTING CHEMICALS

(75) Inventors: Walter S. Going, Houston, TX (US); David H. Green, Houston, TX (US)

(73) Assignee: BAKER HUGHES INCORPORATED, Houston, TX (US)

(21) Appl. No.: 13/160,747

(22) Filed: Jun. 15, 2011

(51) Int. Cl. F16K 11/20; G01F 11/00

(52) U.S. Cl. 137/12; 137/637

(57) ABSTRACT

A valving system includes, a plurality of flow control valves, a plurality of chemical injection devices, and a control line in selective operable communication with at least one of the plurality of flow control valves and at least one of the plurality of chemical injection devices.

### BACKGROUND

Tubular systems for transporting fluids often incorporate remotely operated valves. In fields, such as hydrocarbon recovery and Carbon Dioxide sequestration, for example, such remotely controlled valves are employed to control downhole flows. In a wellbore, for example, such valves are placed within producing zones to allow control and shut-in of the producing zones. In many cases a well may have multiple producing zones such that multiple flow control valves are used to balance production, optimize production and shut off particular zones. These downhole valves use hydraulic lines that run between the valves and surface so that an individual can remotely operate the valves.

In some wells, downhole chemical injection systems are run to supply various chemicals to prevent scaling, foaming, asphaltine deposition and other undesirable events from occurring or improve the efficiency of production or injection. In the case where downhole flow control valves are used, each zone may have a separate chemical injection valve associated with it. In a few instances the wellhead may have a sufficient number of wellhead penetrations to accommodate a separate injection line to each chemical injection valve. In most cases, however, the chemical injection valves must be run on a common chemical injection line. In such cases all of the chemical injection valves provide chemicals whenever chemical injection is taking place. These systems can waste chemicals and damage the formation by causing precipitates to form. Systems and methods to address the foregoing drawbacks are well received in the art.

### BRIEF DESCRIPTION

Disclosed herein is a valving system. The valving system includes a plurality of flow control valves, a plurality of chemical injection devices, and a control line in selective operable communication with at least one of the plurality of flow control valves and at least one of the plurality of chemical injection devices.

Further disclosed herein is a method of injecting chemicals at a plurality of locations. The method includes, supplying chemical via a single chemical supply line to a plurality of chemical injection devices, each of the plurality of chemical injection devices is in operable communication with a flow control valve. Increasing pressure in a selected one of a plurality of control lines in operable communication with one of the plurality of chemical injection devices and the flow control valve, and altering the selected one of the plurality of chemical injection devices with the increasing pressure to allow injection of chemical without opening the flow control valve in operable communication therewith.

### BRIEF DESCRIPTION OF THE DRAWINGS

The following descriptions should not be considered limiting in any way. With reference to the accompanying drawings, like elements are numbered alike:

FIG. 1 depicts a schematic view of a valving system disclosed herein;

FIG. 2 depicts a schematic view of a chemical injection device disclosed in the valving system of FIG. 1;

FIG. 3 depicts a schematic view of an alternate embodiment of a valving system disclosed herein;

FIG. 4 depicts a schematic view of a chemical injection control valve disclosed in the valving system of FIG. 3

FIG. 5 depicts a schematic view of another alternate embodiment of a valving system disclosed herein; and

FIG. 6 depicts a schematic view of a solenoid valve of FIG. 5 disclosed herein.

### DETAILED DESCRIPTION

A detailed description of one or more embodiments of the disclosed apparatus and method are presented herein by way of exemplification and not limitation with reference to the Figures.

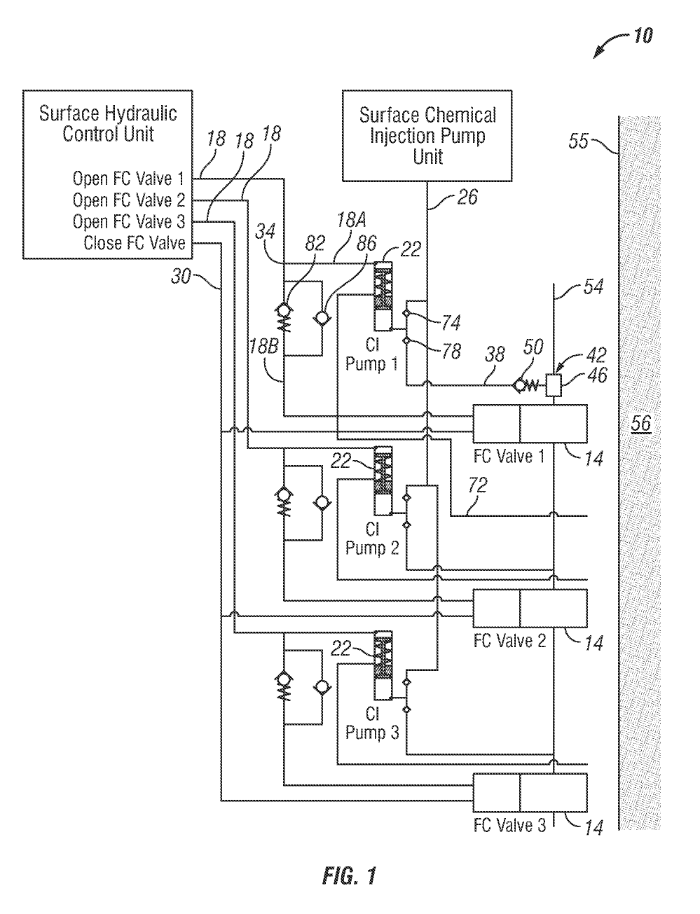

Referring to FIG. 1, an embodiment of a valving system disclosed herein is illustrated at 10. The valving system 10 includes, a plurality of flow control devices 14 (three being shown) and at least one control line 18 (three being shown) being in operable communication with at least one of the plurality of flow control devices 14 and configured to open the flow control device 14 in response to a selected increase in pressure therewithin. The system 10 further includes, at least one chemical injection device 22 (three being shown) in operable communication with the control line 18. The valving system 10 being configured to alter the chemical injection device 22 to permit injection of chemicals at pressures within the control line 18 that are insufficient to open the flow control valve 14. Since in FIG. 1 three sets of the foregoing structures are illustrated and they are operationally similar to one another the following descriptions will focus on just one set. It should be noted however that a common chemical supply line 26 and a common “close valve” control line 30 is operably connected to each of the sets in the Figure.

The control line 18 includes a tee 34 that provides pressure to the chemical injection device 22 through the control line 18A and to the flow control device 14 through the control line 18B. As such hydraulic actuation of the flow control device 14 is openable and closable in response to pressure supplied thereto through the control line 18B and the close control line 30. The chemical injection device 22 is actuated to inject chemical through an injection line 38 to a selected location 42, through an injection nipple 46 and an optional relief valve 50. Note the location 42 can be wherever injection of chemical is desired. For example, in a downhole application, such as in the hydrocarbon recovery or carbon dioxide sequestration industries, the location 42 may be on either an inside or an outside of a tubular 54, illustrated herein as a tubular string within a borehole 55 in an earth formation 56.

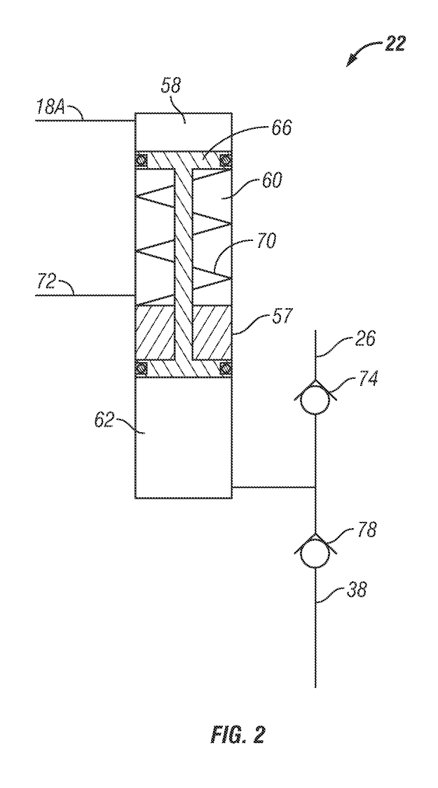

Referring to FIG. 2, the chemical injection device 22 of this embodiment is a chemical injection pump (CIP). The CIP 22 has a housing 57 and a piston 66 sealably movable therewithin that defines three chambers 58, 60, 62. A biasing member 70, illustrated herein as a compression spring, biases the piston 66 in a direction so that a volume of the first chamber 58 is minimized while volumes of the second chamber 60 and the third chamber 62 are maximized. The second chamber 60 is vented through vent line 72; and optionally to an outside of the tubular 54 (see FIG. 1). The third chamber 62 is filled with chemical supplied thereto via the chemical supply line 26 through a check valve 74. The CIP 22 is actuated when fluid is pumped into the first chamber 58 through control line 18A at pressure sufficient to overcome the biasing force of the biasing member 70 and opening pressures of check valve 78 and optional relief valve 50 (FIG. 1). Such actuation causes chemical to flow out of the third chamber 62 and through the injection nipple 46 through injection line 38. Volumes of the chambers 58, 60 and 62 can be selected to permit a known quantity of chemical to be injected during a single actuation and full stroke of the piston 66 of the CIP 22.

Referring again to FIG. 1, the opening pressure of the flow control valve 14 and the actuating pressure of the CIP 22 can be set to assure that the CIP 22 can be repeatably actuated and reset (i.e. chamber 62 refilled with chemical) without the flow control valve 14 ever changing position. Additional control to assure these operational conditions can be gained by inclusion of an optional pressure relief valve 82, after the tee 34 in the control line 18, having an opening pressure greater than the actuating pressure of the CIP 22. This will isolate the control line 18B from pressure cycles used to operate the CIP 22. An optional reverse check valve 86 in parallel with the relief valve 82 allows fluid to flow backwards through the control line 18B, for example, during closure of the flow control valve 14 after it has been opened.

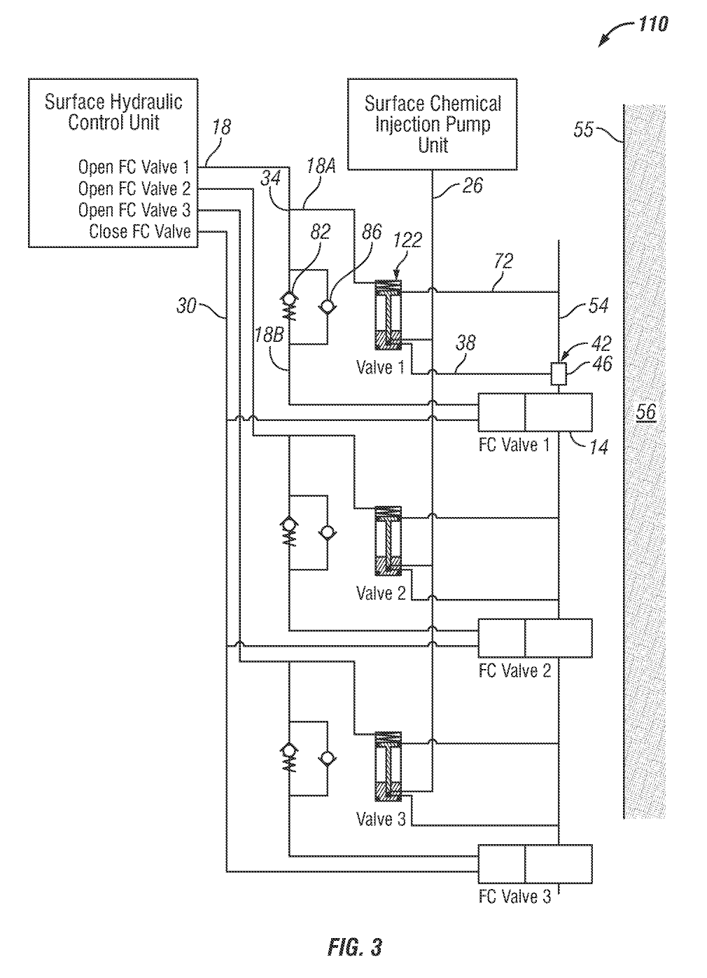

Referring to FIG. 3, an alternate embodiment of a valving system disclosed herein is illustrated at 110. The valving system 110 has several things in common with the valving system 10 and common items are identified with the same reference characters, descriptions of which are not repeated hereunder. A primary difference between the system 110 and the system 10 is the replacement of the chemical injection pump 22 with a chemical injection control valve 122. In this embodiment chemical is injected through the common chemical supply line 26, through the chemical injection control valve 122, through the injection line 38 and out the chemical injection nipple 46 when the chemical injection control valve 122 is in the open position. Conversely, no chemical flows when the chemical injection control valve 122 is closed.

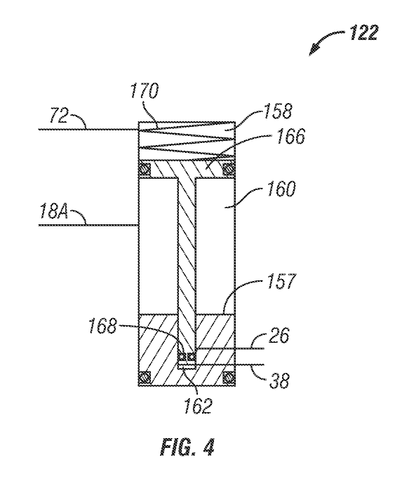

Referring to FIG. 4, the chemical injection control valve 122 has a housing 157 and a piston 166 slidably sealingly engaged therewith that define chambers 158, 160, 162. A biasing member 170, illustrated herein as a compression spring, located within the first chamber 158 biases the piston 166 in a direction that causes a volume of the second chamber 160 and the third chamber 162 to be minimized The injection line 38 is always in fluidic communication with the third chamber 162 while the common chemical supply line 26 is not. The chemical supply line 26 is blocked from fluid communication with the third chamber 162 by a stem 168 of the piston 166 when the chemical injection control valve 122 is closed and is in fluidic communication with the third chamber 162 when the chemical injection control valve 122 is open and the stem 168 is lifted sufficiently to allow fluid to enter the third chamber 162 from the chemical supply line 26. As such, chemical is free to flow from the supply line 26 through the third chamber 162 and out through the injection line 38 when the valve 122 is open.

The biasing member 170 maintains the valve 122 in a normally closed position by urging the piston 166 to a position wherein the stem 168 blocks the common chemical supply line 26. Pressure supplied to the second chamber 160 via the control line 18A overcomes the biasing force of the biasing member 170 at a selected pressure and moves the piston 166 to open the valve 122. The vent line 72 provides venting to the first chamber 158 to prevent hydraulic locking of the piston 166 within the housing 157.

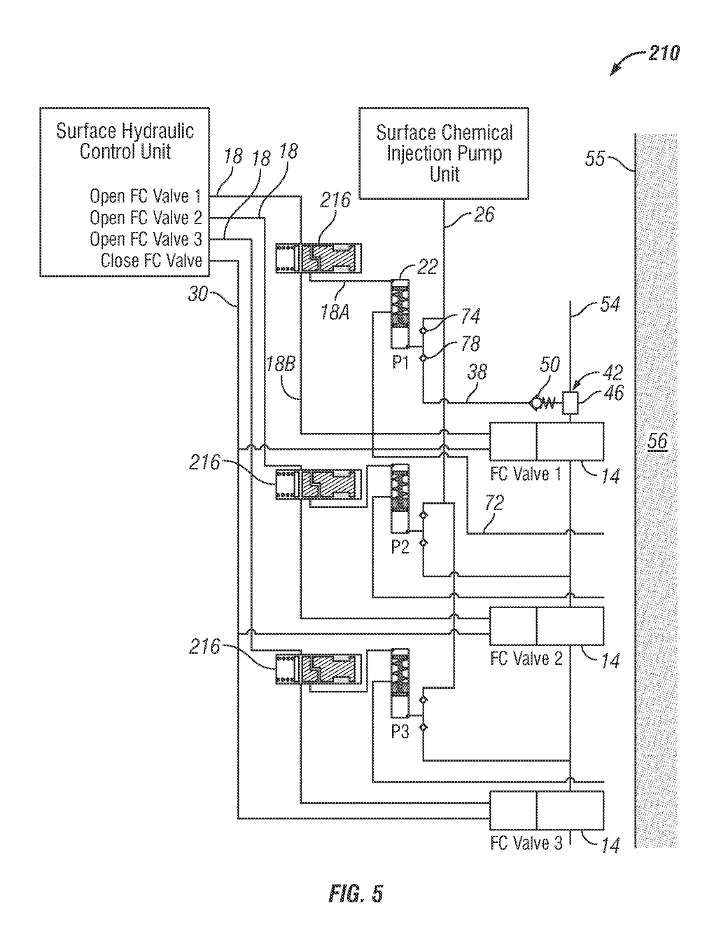

Referring to FIG. 5, a third embodiment of a valving system disclosed herein is illustrated at 210. The embodiment 210 is similar to the valving system 10 described above. The major difference being replacement of the tee 34, the optional pressure relief valve 82 and the optional check valve 86 with a three-way electrically operated solenoid valve 216.

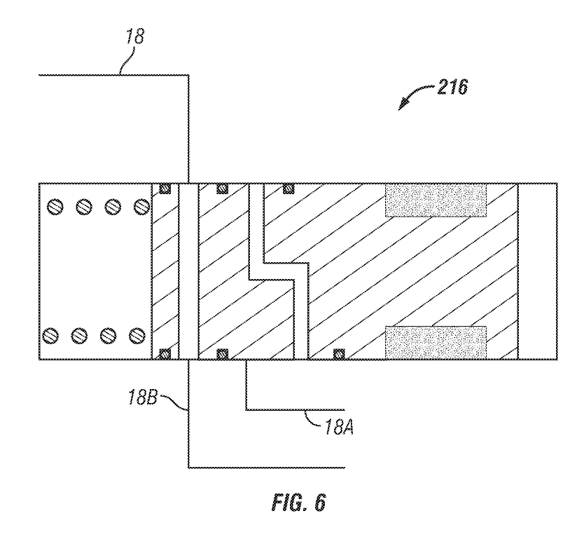

Referring to FIG. 6, in a de-energized state the solenoid valve 216 will allow pressure to be communicated from the control line 18 to the control line 18B thusly enabling a remote hydraulic control system, such as one located at surface, for example, to operate the flow control valve 14. In an energized state the solenoid valve 216 will allow the pressure in the control line 18 to be communicated to the control line 18A thereby enabling a remote hydraulic control system to be utilized for controlling the chemical injection device 22. When a plurality of flow control valves 14 exist, as illustrated in FIG. 5, each of the solenoid valves 216 can be operated independently or simultaneously as a group.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A valving system comprising:
a plurality of flow control valves;
a plurality of chemical injection devices; and
a control line in selective operable communication with at least one of the plurality of flow control valves and at least one of the plurality of chemical injection devices.

2. The valving system of claim 1, wherein the selective operation is via response to pressure in the control line.

3. The valving system of claim 1, wherein pressure changes within the control line can operate the chemical injection device while leaving the flow control valve un-operated.

4. The valving system of claim 1, further comprising an electrically actuated valve configured to control the selective operation between the one of the plurality of chemical injection devices and the one of the plurality of flow control valves.

5. The valving system of claim 1, wherein a separate control line is in operable communication with each of the plurality of flow control valves and each of the plurality of chemical injection devices.

6. The valving system of claim 1, wherein a single chemical supply line is in operable communication with a plurality of the plurality of chemical injection devices.

7. The valving system of claim 1, wherein the valving system is further configured to reset the one of the plurality of chemical injection devices to its original configuration after operation thereof upon a drop in pressure within the control line.

8. The valving system of claim 1, further comprising a pressure relief valve in the control line and in operable communication with the one of the plurality of flow control valves configured to require greater pressures to operate the one of the plurality of flow control valves than would be required if the pressure relief valve were not present.

9. The valving system of claim 1, further comprising a one-way valve in operable communication with the one of the plurality of flow control valves configured to allow pressure supplied to open the one of the plurality of flow control valves to decrease and thereby permitting the one of the plurality of flow control valves to close.

10. The valving system of claim 1, wherein the one of the plurality of chemical injection devices is a pump.

11. The valving system of claim 10, wherein the pump injects a selected amount of chemical per actuation thereof.

12. The valving system of claim 10, wherein the pump can be cycled repeatedly without opening the one of the plurality of flow control valves.

13. The valving system of claim 1, wherein the at least one chemical injection device is a valve.

14. The valving system of claim 13, wherein the valve can be opened and closed repeatedly without opening the one of the plurality of flow control valves.

15. A method of injecting chemicals at a plurality of locations, comprising:
supplying chemical via a single chemical supply line to a plurality of chemical injection devices, each of the plurality of chemical injection devices being in operable communication with a flow control valve;
increasing pressure in a selected one of a plurality of control lines in operable communication with one of the plurality of chemical injection devices and the flow control valve; and
altering the selected one of the plurality of chemical injection devices with the increasing pressure to allow injection of chemical without opening the flow control valve in operable communication therewith.

16. The method of injecting chemicals at a plurality of locations of claim 15, wherein the altering the selected one of the plurality of chemical injection devices includes actuating a pump.

17. The method of injecting chemicals at a plurality of locations of claim 15, wherein the altering the selected one of the plurality of chemical injection devices includes opening a valve.

18. The method of injecting chemicals at a plurality of locations of claim 15, further comprising:
decreasing pressure in the selected one of a plurality of control lines in operable communication with the one of the plurality of chemical injection devices and the flow control valve; and
resetting the one of the plurality of chemical injection devices with the decreasing pressure to halt injection of chemical therethrough without opening the flow control valve in operable communication therewith.

19. The method of injecting chemicals at a plurality of locations of claim 15, further comprising increasing pressure further in the selected one of the plurality of control lines in operable communication with the one of the plurality of chemical injection devices and the flow control valve and opening the flow control valve.

20. The method of injecting chemicals at a plurality of locations of claim 15, further comprising electrically altering a valve to selectively port fluid communication between the selected one of the plurality of control lines and one of the one of the plurality of chemical injection devices and the flow control valve in operable communication therewith.
